(19) United States
(12) Patent Application Publication
(10) Pub. No.: US 2017/0167661 A1
(43) Pub. Date: Jun. 15, 2017

(54) Composite Material Container and the Forming Method of its Composite Material Layer

(71) Applicant: SINOMA SCIENCE & TECHNOLOGY(SUZHOU) CO., LTD., Jiangsu (CN)

(72) Inventors: Mingao Yang, Jiangsu (CN); Huan Kuang, Jiangsu (CN); Meilin Li, Jiangsu (CN); Hong Zhang, Jiangsu (CN)

(21) Appl. No.: 15/442,707

(22) Filed: Feb. 27, 2017

Related U.S. Application Data
(63) Continuation of application No. PCT/CN2015/078938, filed on May 14, 2015.

(30) Foreign Application Priority Data
Aug. 29, 2014 (CN) 201410438888.7

(51) Int. Cl. F17C 1/06; B29C 70/32

(52) U.S. Cl. CPC F17C 1/06; B29C 70/326; F17C 2201/0109; F17C 2203/0614; F17C 2203/0663; F17C 2203/0636; F17C 2209/2154; F17C 2205/0323; F17C 2260/011; B29K 2105/0809

(57) ABSTRACT

The present invention provides the composite material layer forming method of composite material container: wrap a continuous fiber around the surface of inner tank at a predetermined angle to form at least a layer of composite material, and tile an additive between composite material layers and/or inner surface and/or outer surface to prevent cracking along a fiber direction of the composite material layer.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2015/078938, with an international filing date of May 14, 2015, which in turn claims priority from Chinese Application No. 201410438888.7, filed on Aug. 29, 2014. This application is a continuation of International Application No. PCT/CN2015/078938. International Application No. PCT/CN2015/078938 is pending as of the filing date of this application, and the United States is a designated state in International Application No. PCT/CN2015/078938. This application claims the benefit under 35 U.S.C. §119 from Chinese Application No. 201410438888.7. The disclosure of each of the foregoing documents is incorporated herein by reference.

### TECHNICAL FIELD

The present invention relates to a gas transportation technology, and in particular, to a composite material container and the forming method of its composite material layer.

### BACKGROUND

Prior art is used to transport natural gas, hydrogen and helium and realize transportation mainly by increasing storage pressure. With the development of gas industry, there is an increasing demand for pressure of gas storage transportation container.

The inner tank of high-pressure composite container (gas cylinder) produced according to prior art is made of metal materials. In order to increase the volume and bearing pressure of composite container (gas cylinder), common method is to use tip spinning method with high-pressure seamless metal tube to make inner tank. Then wrap a layer of high strength fiber material on the outer surface of inner tank and increase bearing pressure with traction of high strength fiber material. Prior art may cause cracks along fiber direction due to increasing pressure. With the increase of frequency of use and impact of specific environment, these cracks will tend to spread and may lead to cracking of the whole composite layer if it is serious.

In view of this, there is an urgent need for a new technology to effectively reduce or eliminate cracking of the composite material layer.

### SUMMARY

It is therefore an object of the present invention to overcome the defects of the prior art, this present invention provides a composite material container which can reduce and even eliminate the cracking of the composite material layer and the forming method of the composite material layer.

To achieve the above-mentioned purpose, the present invention provides a forming method of composite material layer of composite container: a fiber is wrapped around the outer surface of inner tank at a predetermined angle to form at least one composite material layer. A layer of additive is added between composite material layers and/or on the inner surface of composite material layers and/or on the outer surface of composite layers to prevent cracking of composite material layer.

Further, the additive is located between two composite material layers.

Further, the additive is fabric or non-woven fabric.

Further, the additive is in the shape of fibrous, lamellar, flocculent and block.

Further, the additive is made of metal or nonmetal material.

Further, the additive is made of fiber materials. The fiber materials are composed of one or more of the following materials: carbon fiber, glass fiber, aramid fiber, polyester fiber and metal fiber.

Further, the continuous fiber is wrapped along the outer surface of inner tank in the shape of ring.

Further, the continuous fiber is wrapped along the outer surface of inner tank in the spiral shape.

This present invention provides a kind of composite material container which is composed of an inner tank and composite material layer. The composite material layer is made according to any method of claim 1-9.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

The advantages and purpose of the present invention can be understood through the following detailed description of the present invention and drawings.

FIG. 1 is a schematic diagram of the present invention.

FIG. 2 is a schematic diagram of partial enlargement of the present invention.

### DETAILED DESCRIPTION

Reference will now be made in detail to some embodiments of the invention, examples of which are illustrated in the accompanying drawings.

Current composite material container (gas cylinder) is formed by hoop wrapping fibers. Because the shrinkage rates between composite material layers wrapped round the built-in metal inner tank's outside surface and the built-in metal inner tank are inconsistent, the length of gas cylinder is extended in the process of repeatedly filling. The extension of metal material is better than that of composite material. Then after repeatedly filling, the extending length of metal is more than the length of composite material, which may cause cracking of circular direction on the surface of composite material. After increasing pressure, it will crack along fiber direction. With increase of using frequency and impact of specific environment, these cracks may tend to extend. If it is serious, it may cause cracking of the whole composite material layer. Therefore, the purpose of this present invention is to provide a kind of composite material container and forming method of composite material layer for prevention of cracking of the continuous fiber layer.

The present invention analyzes and calculates the matching longitudinal force of fiber circular wrapping and uses the enhancement technology in the process of composite material layer forming. When the composite material layer of gas cylinder cracks along the fiber direction in the process of increasing pressure and strength, it provides a pulling force perpendicular to cracking direction, so as to reduce cracking and long-term extension phenomenon.

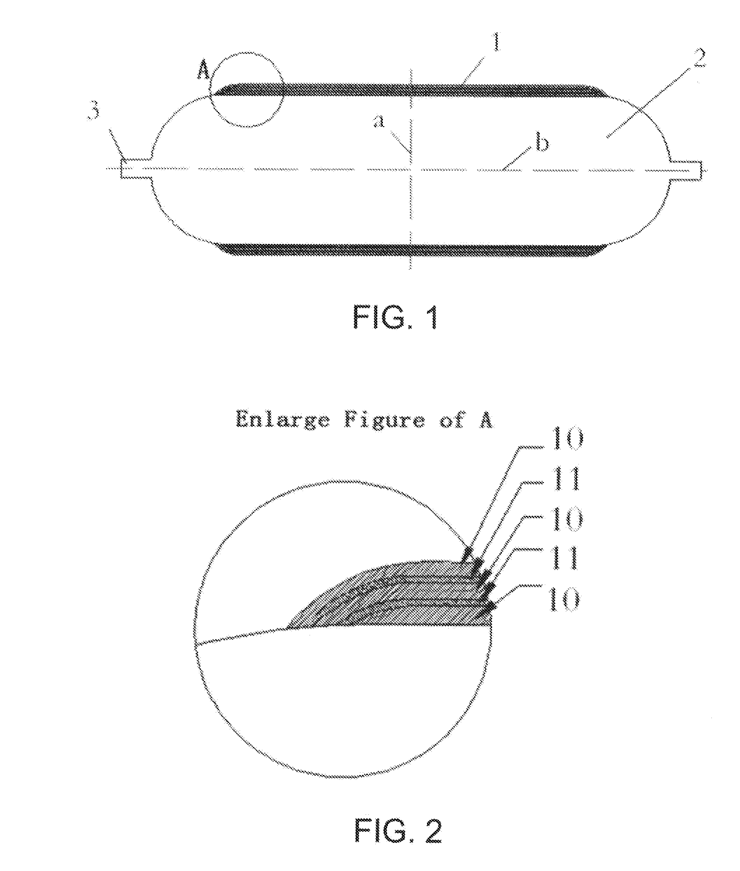

As shown in FIG. 1, FIG. 1 is the schematic diagram of the structure of the composite material container involved in the present invention. The composite material container can be a cylinder used for containing high pressure gas, and can also be a pipeline for high pressure gas, liquid or solid. FIG. 1 is an implementation method. The container 2 is made of high quality seamless steel pipe, and two cylinder necks 3 in both sides of the steel pipe are processed according to the end spinning method. The built-in screw of the cylinder necks 3 is used to fix the front end and back-end plugs. Gas inlet and outlet valves are located in the front plug and a safe relief device is located in the back plug (it is not shown in the figure). In the other embodiment, the steel cylinder can also include an opening.

The outer surface of the steel cylinder 2 includes a composite material layer 1. Composite material layer 1 is usually wrapped with continuous fiber along circular direction (a). Composite material layer 1 can only cover partial surface of the steel cylinder 2, and can also cover the whole surface of cylinder 2, including the outer surface of the cylinder neck 3. As shown in FIG. 1, it is a typical circular wrapped composite material container. The circular winding is almost vertical between continuous fiber winding angle and axial direction (b) of gas cylinder. The problem of circular winding cylinder is that: when the cylinder is filled with high-pressure gas and the contraction rates of metal tank and composite material layer are inconsistent, which cause cracking of circular direction (a) on composite material layer. This present invention provides a compensative force in longitudinal direction to overcome circular cracking.

In the other embodiment, the whole winding or wide angle winding method is adopted for the composite material container. When adopting this method, cracks will appear along the continuous fiber parallel direction. According to technical solution offered by this present invention, a compensative force in the vertical angle with continuous fiber is required to overcome cracks.

As shown in FIG. 2, it is the partial amplification of composite material container in the present invention. Different from the prior art, the composite material layer 1 offered in the present invention includes an additive 11 besides continuous fiber 10. It increases a longitudinal force (b in FIG. 1) matching with circular pulling force in the forming process of composite material layer so as to reduce surface cracking and long-term crack extension phenomenon.

In a preferred embodiment, the continuous fiber 10 and additive 11 are continuous molding. That is a layer of additive 11 covered above or below a layer of continuous fiber 10. Additive 11 can be fabric and also be non-woven fabric. The fabric is a material which is formed by over two crossed and wound lines. Additive 11 can be in the shape of fibrous, lamellar, flocculent and block. If it is in the shape of fibrous, the additive 11 will be arranged longitudinally or extended with a certain angle longitudinally.

Additive 11 can be made of carbon fiber, glass fiber, aramid fiber, polyester fiber and metal fiber. Carbon fiber (Carbon fiber, referred to as CF), is a new type of fiber material with high strength and high modulus fiber containing more than 95% carbon content. It is crystallite graphite material (through carbonization and graphitizing) made up of organic fibers, such as flake graphite crystallites, which are piled along the axial direction of the fiber. Carbon fibers include, but are not limited to polyacrylonitrile-based carbon fiber, pitch based carbon fiber, viscose based carbon fiber, phenolic based carbon fiber and vapor grown carbon fiber. The components of glass fiber (glass fiber or fiberglass) are silica, alumina, calcium oxide, boron oxide, magnesium oxide and sodium oxide that are made through high-temperature melting, wire drawing, winding and weaving. The glass fibers include, but are not limited to non-alkali glass fiber, C-glass fiber, high alkali glass fiber, high strength glass fiber, high modulus fiber glass, high silica glass fiber, alkali-resistant glass fiber and other glass fiber. The full name of aramid fiber is poly-p-phenylene terephthamide (Aramid fiber), which comprises PPTA and PMIA. The metal fiber is mainly made of metal (iron, iron alloy, steel, etc.) with technical methods such as cutting off the thin steel wire, cold-rolled steel belt shearing, ingot milling, or rapid condensation of liquid steel with the length/diameter ratio of 40-80 (when fiber cross section is not round, the converted equivalent cross section diameter will be adopted.)

The present invention also provides a forming method of composite material, which is achieved by adding fiber fabric in the process of winding composite material around the container. There are a wide range of fabrics such as carbon fiber fabric, glass fiber fabric, aramid fiber fabric or its mixed fiber as well as fiber fabric of prepreg resin matrix. First, when choosing fiber fabric, its surface infiltration agent must be compatible with the system of continuous fiber and resin system, so that in the process, fiber fabric, continuous fiber system and resin matrix make into a whole wrapped around the composite material layer and bear load as a whole. At the same time, in the long-term use process, stratification phenomenon of two materials that may affect service life of gas cylinder doesn't occur. Second, use horizontal tile method to overlay fiber fabric on some circular wrapped layer (may be bottom or any outer layer) that has been analyzed and calculated. Then use resin matrix to impregnate it (the impregnation process can be omitted if choosing pre-immersion matrix resin). After overlaying, it shall be wrapped continuously and wrap the overlaid fiber fabric around the wrapped layer. The fiber fabric overlaying position and number of layers can be analyzed, calculated and adjusted according to actual situation of the product.

The following will provide a method for producing composite material container involved in this present invention. First, choose inner tank made of high-pressure seamless steel of suitable length according to designed capacity, then position the inner tank on a rotating axis and make high strength composite material layer on the surface of inner tank.

The composite material layer preparation steps: choose impregnating compound compatible with continuous fibers used for wrapping and resin matrix, and use fiber fabric, continuous fiber used for wrapping, resin matrix, and surface impregnating compound to form a wrapped composite material layer as a whole through solidifying.

Wrap fiber impregnated resin matrix around the circular container (inner tank) according to parameters in form 1 below:

Form 1

| | | |
|---|---|---|
| No. | Item | Parameter |

| | | | |
|---|---|---|---|
| 1 | Winding speed | ≦60 | m/min |
| 2 | Twisted fiber | 240-300 | N |
| | tension | | |
| 3 | Glue liquid | 35-50° | C. |
| | temperature | | |
| 4 | Yarn width | 18-20 | mm |

| | | |
|---|---|---|
| 5 | Gumming | Requirement: without dipping glue on |
| | | the surface of product, no adhesive |

Wind till a specific layer and then stop winding. Overlay the additive on the composite material specific layer that is the layer n (n is a natural number). Those skilled in the art can set the location of specific layer according to designed structure size of gas cylinder, key points, line layout and the symmetry of the structure.

Continuous fiber can be wrapped circularly on the surface of inner container and also can be wrapped in a certain angle (spiral winding). In the winding process, you can overlay the additive in 90° direction with the circular direction or 30° with the axis direction of gas cylinder.

After completion of winding, adopt horizontal rotation staged temperature curing method for composite material, and cure 4-5 hours in the staged temperature 95˜155° C. In the process, the gas cylinder should be rotated horizontally to ensure well-distribution of glue on the surface of gas cylinder.

Use hoop-wrapped composite cylinder (external diameter of inner tank: 406 mm, whole length: 2140 mm) as the reference sample. Before filling, the straight-line length of the gas cylinder is 1650 mm, and after experiencing 15000 times of repeated charge and discharge under 25 MPa work pressure, the straight-line length of the gas cylinder's inner tank is 1670 mm and metal liner length changes by 20mm. But the straight-line length of composite material layer changes little. Because of inconsistence of both lengths, composite material layer cracks obviously and the widest width of single circular crack can reach 7 mm.

Use hoop-wrapped composite cylinder (external diameter of inner tank: 406 mm, whole length: 2140 mm) as the reference sample. The straight-line length of gas cylinder's inner tank changes from 1650 mm to 1670 mm and metal liner length changes by 20 mm after experiencing 15000 times of repeated charge and discharge under 25 MPa work pressure. The change rate of gas cylinder's inner tank is 1.2%. But because of compensation for longitudinal force, the outer surface of hoop-wrapped composite gas cylinder filled with additives only has some evenly-distributed circular cracks and the widest width of each crack is less than 2 mm.

### INDUSTRIAL APPLICABILITY

Compared with the prior art, the present invention provides composite material container and forming technology of composite material layer. There is a longitudinal (axial) reinforcing effect within wrapped composite material layer to effectively prevent composite material cracking or crack extension. That can prevent cracking or cracking extension along fiber of wrapped composite layer in the long-time use process and to some extent, stabilize the performance of container and thereby, improve the safety of container in the use process.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method of forming composite material layers of a composite material container, the method comprising:
wrapping continuous fiber around a surface of an inner container in a predetermined angle to form at least one composite material layer; and
tiling an additive between the composite material layers and/or on an inner surface of the composite material layers and/or on an outer surface of the composite material layers to prevent cracking along a fiber direction of the at least one composite material layer.

2. The forming method of claim 1, wherein that the additive is located between two composite material layers.

3. The forming method of claim 1, wherein the additive is fabric or non-woven fabric.

4. The forming method of claim 1, wherein the shape of additive is fibrous, lamellar, flocculent and block.

5. The forming method of claim 1, wherein the additive is made of metal or nonmetal material.

6. The forming method of claim 1, wherein the additive is made of fiber materials.

7. The forming method of claim 6, wherein the fiber materials are made of the following one or several materials: carbon fiber, glass fiber, aramid fiber, polyester fiber and metal fiber.

8. The forming method of claim 1, wherein the continuous fiber is wrapped circularly around the surface of the inner container.

9. The forming method of claim 1, wherein the continuous fiber is wrapped spirally around the surface of the inner container.

10. A composite layer container, comprising:
an inner container;
an additive; and
composite material layers that are formed by wrapping continuous fiber around a surface of the inner container in a predetermined angle and by adding an additive between the composite material layers and/or on an inner surface of the composite material layers and/or on an outer surface of the composite material layers to prevent cracking along a fiber direction of the composite material layers.

11. The composite layer container of claim 10, wherein that the additive is located between two composite material layers.

12. The composite layer container of claim 10, wherein the additive is fabric or non-woven fabric.

13. The composite layer container of claim 10, wherein the shape of additive is fibrous, lamellar, flocculent and block.

14. The composite layer container of claim 10, wherein the additive is made of metal or nonmetal material.

15. The composite layer container of claim 10, wherein the additive is made of fiber materials.

16. The composite layer container of claim 15, wherein the fiber materials are made of the following one or several materials: carbon fiber, glass fiber, aramid fiber, polyester fiber and metal fiber.

17. The composite layer container of claim 10, wherein the continuous fiber is wrapped circularly around the surface of the inner container.

18. The composite layer container of claim 10, wherein the continuous fiber is wrapped spirally around the surface of the inner container.
